(19) United States
(12) Patent Application Publication
(10) Pub. No.: US 2013/0266699 A1
(43) Pub. Date: Oct. 10, 2013

(54) MIRCOWAVABLE FOOD CONTAINERS FOR HIGH PRESSURE PROCESS FOOD PRESERVATION AND RECONSTITUTION

(71) Applicant: H.J. HEINZ COMPANY, Pittsburgh, PA (US)

(72) Inventors: Jonathan MIDDIS, Elwood (AU); Dragoljub ZEC, Hampton (AU)

(73) Assignee: H.J. HEINZ COMPANY, Pittsburgh, PA (US)

(21) Appl. No.: 13/826,439

(22) Filed: Mar. 14, 2013

Related U.S. Application Data
(60) Provisional application No. 61/621,188, filed on Apr. 6, 2012.

(51) Int. Cl. B65D 81/34; A23L 1/00

(52) U.S. Cl. CPC B65D 81/3461; A23L 1/0008
USPC 426/113; 219/735; 426/394

(57) ABSTRACT

A free-standing, microwavable food container capable of being used for both high pressure processing (HPP) and microwave reconstitution of food products. The container is designed so as to be capable of being hand-held, even after microwave heating of the food products contained therein. The design of the container, coupled with the incorporation of the pressure release valve, enables the container to be used to both HPP preserve the food product and reconstitute the food product in the same container while retaining the original organoleptic properties of the preserved food, including taste, texture and appearance. A method of combining the high pressure processing of food products and microwave reconstitution in the stand-up container containing the pressure release valve is also described. Typical food products preserved include vegetables, proteins and/or carbohydrates, optionally coated or mixed with powdered, pellet or cube sauce or gravy.

### CROSS-REFERENCE TO RELATED APPLICATIONS

The instant application claims the benefit under 35 U.S.C. §119(e) of U.S. provisional application No. 61/621,188 filed Apr. 6, 2012, the disclosure of which is hereby expressly incorporated by reference hereto in its entirety.

### TECHNICAL FIELD

The field of art to which this invention generally pertains is food container packaging for heating or cooking food.

### BACKGROUND

While high pressure processing (HPP) of food products has represented a great way to preserve various foods, reconstituting such food products after storage has presented some special challenges. In reconstituting such food products, it is not uncommon to lose much of the preserved organoleptic properties because of the difficulty in controlling the food reconstitution conditions, such as heat, moisture content, etc. Re-heating such products in a microwave environment has also presented special problems because of the added difficulty of applying reconstitution conditions in a controlled fashion.

Accordingly, methods for preserving and reconstituting such foods to take advantage of these preservation methods would be particularly advantageous.

### BRIEF SUMMARY OF THE INVENTION

A microwavable container particularly adapted for containing food products for preserving and reconstituting such foods is described. The container has at least two side-wall sections and a bottom section, the side-wall sections and bottom section being substantially transparent to microwave energy. The container also has at least one side-wall section containing an internal pressure release valve. The bottom section is also of a size sufficient to support the side-wall sections in a substantially vertical, free-standing position. The container and the valve are configured so as to be useful for both high pressure processing and microwave reconstitution of food products in the same container.

Embodiments of the invention include: the microwavable container described above, where the bottom section is configured so as to be capable of being hand-held even after microwave heating; the microwavable container described above, where the upper portion of the side walls is removable for easy access to food contents after microwaving; the microwavable container described above, containing one or more vegetable, protein, and/or carbohydrate food products sealed inside the container; the microwavable container described above, where the food products are coated or mixed with sauce or gravy in powdered, pellet or cube form.

Additional embodiments of the invention include: a method of preserving and reconstituting food product by placing the food product in a free-standing, microwavable container containing an internal pressure release valve, and sealing the container, subjecting the container to high pressure processing to preserve the food products, maintaining the food product in a preserved state until time of reconstitution, and subjecting the preserved food product contained in the sealed container to sufficient microwave energy to reconstitute the preserved food product, resulting in a reconstituted food product which exhibits its substantially original preserved organoleptic properties; the method described above where the organoleptic properties include taste, texture, appearance and nutritional properties; the method described above, where the preserved food product comprises one or more vegetables, proteins, and/or carbohydrates; and the method described above, where the preserved food products are coated or mixed with sauce or gravy in powdered, pellet or cube form.

These and other objects, aspects, embodiments and features of the invention will become more fully apparent when read in conjunction with the following detailed description.

### BRIEF DESCRIPTION OF THE DRAWINGS

FIG. 1 shows a side view of a food container embodiment according to the present invention.

FIG. 2 shows a bottom view of a food container embodiment according to the present invention.

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments, with occasional reference to the accompanying drawings. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

High pressure processing of food products to eliminate such things as bacteria, yeast and molds, is well known. However, in reconstituting such food products, often the preserved organoleptic properties, such as taste, texture, and appearance, in addition to nutritional properties of the food product, suffer. Not only does the use of the containers of the present invention result in the preservation of much of the organoleptic properties, i.e., more natural taste, texture and appearance, as well as nutritional value, of the HPP processed food products, but it provides the convenience of both HPP preservation of such foods and microwave reconstitution of such foods, in the same container. It also includes a free-standing structure, which provides advantages not only in ease of heating and/or cooking, but in removing the product from the container as well. In addition, with the top section of the container removed, the free-standing structure of the container can provide a bowl-like vessel for direct consumption of the food products contained. And the container is designed in such a way to provide an area away from the heated food area such that the container can be hand-held from the bottom section for further ease of use, e.g., for consuming the heated/cooked food product directly from the microwaved container.

By using the food containers disclosed herein, it is possible to better control the temperature and pressure inside the container during food reconstitution, for better heat distribution within the container. This can also result in the use of lower levels of heat to reconstitute the food products contained in the food container, all of which results in reconstituted food products with superior organoleptic properties.

The food products sealed in the containers of the present invention can be preserved by conventional HPP processing, see for example, Acta Biochemica Polonica, Vol. 52, No. 3/2005, pages 721 to 724, “High Pressure Processing for Food Safety”, the disclosure of which is herein incorporated by reference. Food products such as vegetables (e.g., broccoli, cauliflower, carrots, etc.), proteins (e.g., meats, eggs, dairy products, etc.) and carbohydrates (e.g., pasta, rice, etc.) can be processed according to the present invention. Additionally, the products, can be dipped, rolled, or tumbled in conventional powdered sauces or gravies, or mixed with such sauces or gravies in cube or pellet form, before being sealed in the container and before HPP processing.

The pressure release valve is typically placed in at least one side wall section of the container. The valve can be any valve typically used for microwave processing. See, for example, U.S. Pat. No. 5,989,608, the disclosure of which is herein incorporated by reference. Typically these valves work by opening or expanding when a certain internal pressure is reached in the container, and shrinking or closing when the pressure is reduced or relieved. Note also, U.S. Pat. No. 6,380,524, the disclosure of which is herein incorporated by reference, which describes typical pressures valves of this type are designed to release pressures at (e.g., about 2 to 10 mbr (millibar)), and reclose at (approximately 0.5 mbr). It is also important that the valves used herein maintain their integrity during the HPP processing. In addition to not allowing the contents of the container to seep out during HPP processing, it is also important that the valves not allow anything (e.g., water) to seep into the bag during HPP processing.

By controlling the pressure in the container, in addition to being able to better control the heating and/or cooking level of the food contained, including the heat uniformity and heating level or intensity, the amount of water/steam the food products are subjected to can also be controlled. This contributes to the more natural organoleptic and nutritional benefits related to the use of the container recited above. For example, other methods of HPP reconstitution result in subjecting the food product to an excess of water, i.e., more than is necessary to reconstitute the food product, further contributing to the adverse impact on organoleptic properties of the reconstituted food product. Also, by controlling the amount of water/steam present in the container during reconstitution, the amount of water/steam available to reconstitute any sauces or gravies present on or in the food products can be controlled for maximum organoleptic benefits as well.

By being able to control pressure, steam exposure, and water content during food product reconstitution, this provides a much gentler, controlled heating process for reconstitution of the food product than would otherwise ordinarily occur during HPP food product reconstitution, e.g., controls or eliminates potentially excessive and/or non-uniform heating of the food product being reconstituted.

The sidewalls and bottom sections of the food containers can be made of any material typically used in a microwave environment, such as polyethylene or polypropylene. Accordingly, conventional sealing methods (such as heat bonding, conventional adhesives, etc.) can be used to bond or otherwise attach the side walls together, including the upper portion of the side walls, and attach the side walls to the bottom section as well.

The containers of the present invention can be made in various dimensions, according to what food products are to be contained therein, but would typically have side wall measurements of 15 cm to 20 cm tall by 15 cm to 20 cm wide. For example, for a typical single serving size (light lunch or snack size), a container with a square side wall shape measuring 15 cm to 18 cm, and typically 17 cm, square could be used. The bottom section would be sized accordingly to allow for the container to be free-standing in the vertical position when food filled. For example, for the 17 cm square side wall container described above, the surface area of the bottom section would be approximately 95 cm².

As stated above, the food products are placed in the food containers of the present invention, sealed and preserved using conventional HPP processing, and stored in the containers under either refrigerated or ambient conditions depending on the food contained, until desired for use. The amount of microwave energy used to heat or cook the food product would be that conventionally used to heat or cook food products, for example, an energy setting of 1000 Watt to 1100 Watt, for 30 seconds up to four minutes, depending on the size of the container.

As mentioned above, one of the benefits of using the food containers of the present invention is the more natural organoleptic properties of the reconstituted food products. Not only does this include the appearance, taste and texture of the food products, but the nutritional value as well. But in addition, the fact that the container is designed to withstand both HPP processing and microwave heating and still provide more natural organoleptic properties provides great advantages, both in processing and food quality.

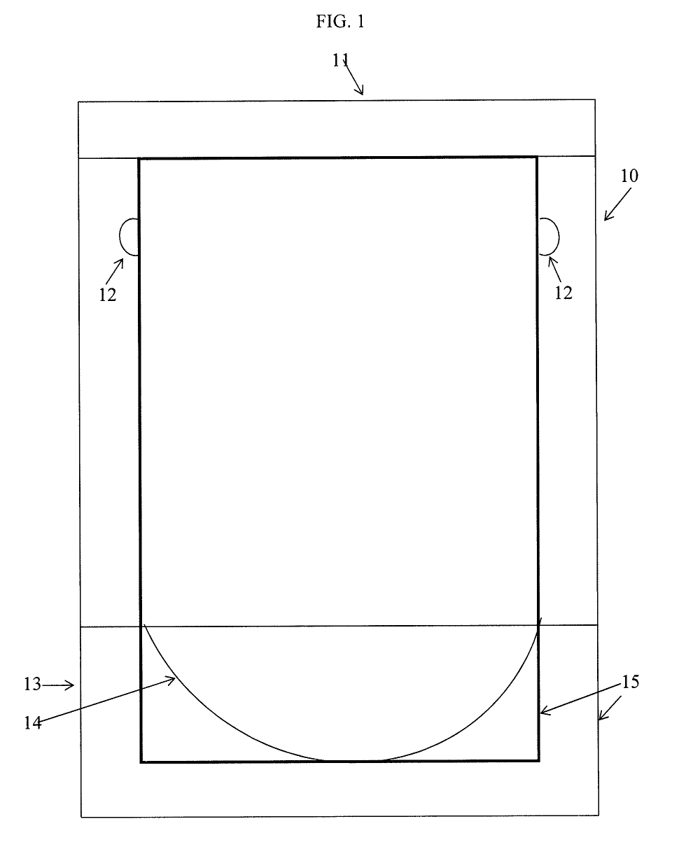

FIG. 1 represents a side view of a typical two side-wall microwavable container (10) according to the present invention. The upper portion (11) of the container is typically easily removable (e.g., tearing, cutting, or pulling apart) for easy access to the food products once they have been heated or cooked. Also shown is one version of pressure release valves (12), typically contained in at least one of the side wall sections of the container, but here shown present on both sides of the container. As stated above, the valves are designed to open up and release the pressure inside the container when the pressure reaches a certain level. The lower section of the container (13), is specifically designed to be able to be hand-held after the microwave heating takes place. The heated food is contained in the semi-circular portion (14) of the container, while the remainder of the lower section (15) remains relative cool to the touch, even after microwave heating, permitting the container to be hand-held.

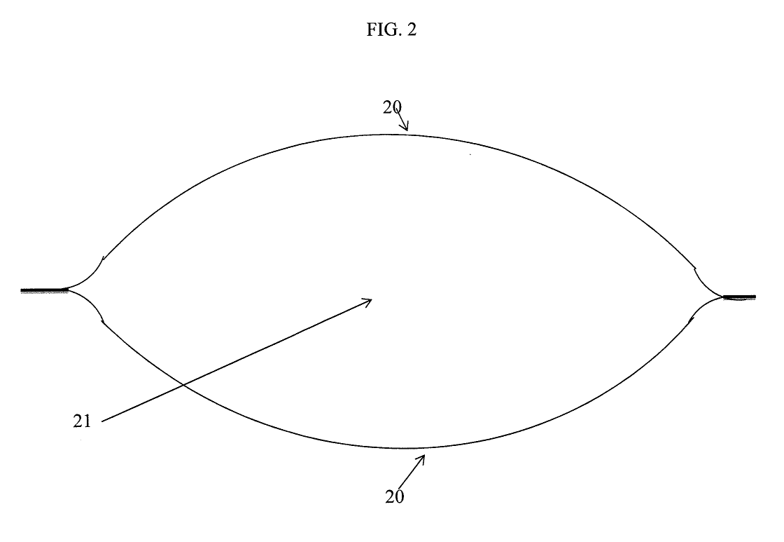

In FIG. 2, which represents a bottom-up view of the container shown in FIG. 1, the side walls (20) are supported by a bottom section (21) of a relative size so as to provide the ability of the container to remain free-standing in the vertical position (e.g., as shown in FIG. 1). And as described in FIG. 1 above, the bottom section of the container (21), is also configured so as to provide unheated (i.e., sections not containing heated food) sections to permit the container to be hand-held.

While the container is depicted above as a two wall version, it is also possible to attain the benefits of the present invention with other side-wall designs, e.g., cylindrical side walls, three side walls, four side walls, etc. A bottom section could easily be fashioned to support a free-standing version of the container, while maintaining the ability to be hand-held as described above, independent of the number or shape of walls desired.

As described above, the upper portion of the side wall section of the container is designed to be removable for easy access to the contents of the container. This can be accomplished by any conventional means, e.g., by providing tear-away perforations at the point of desired opening. Conventional heat sealing of the side walls at the top or upper portion of the container (11), or the inclusion of conventional adhesive or bonding material can also be used in such a way as to provide for separation of the upper portion of the container, e.g., with sufficient pulling force to separate the top (11) of the side walls to allow access to the contained food product. And of course, such access could also be possible independent of the access provided, by simple (e.g., knife or scissors) cutting.

The invention is further illustrated by reference to the following example. It will be apparent to those skilled in the art that many modifications, both to the materials and methods, may be practiced without departing from the purpose and scope of the invention.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

### EXAMPLE

A vegetable mixture of snap peas, red peppers and broccoli spears are rolled in a conventional powdered sauce made up of flour, starches, herbs and spices, vegetable gums etc. The sauce coated vegetables are then placed in a polypropylene pouch as shown in the Figures, having two heat sealed side walls 17 cm tall and 17 cm wide, pressure valves in two sides of the walls (as shown in FIG. 1), calibrated to release water vapor/steam at approximately 3 mbr of pressure, and a bottom section sealed to the side walls, having a surface area of approximately 95 cm² to allow the pouch to be free-standing. The pouch is then heat sealed and subjected to conventional high pressure processing by subjecting the pouch to a high level of hydrostatic pressure (up to 600 MPa/87,000 psi) for a few seconds to a few minutes. After HPP processing, the products are stored until the time of desired food product reconstitution. When desired, and upon heating the pouch in a conventional microwave oven at a power setting of 1100 Watt for one minute and fifty seconds, a vegetable mixture in sauce is produced having exceptional taste, appearance, texture and nutritional value.

The scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A microwavable container particularly adapted for containing food products comprising,
at least two side-wall sections having an upper portion, and a bottom section,
the side-wall sections and bottom section being substantially transparent to microwave energy,
at least one side-wall section containing an internal pressure release valve,
the bottom section being of a size sufficient to support the side-wall sections in a substantially vertical, free-standing position, and
the container and the valve configured so as to be useful for both high pressure processing and microwave reconstitution of food products contained therein.

2. The microwavable container of claim 1, wherein the bottom section is configured so as to be capable of being hand-held even after microwave heating.

3. The microwavable container of claim 1, wherein the upper portion of the side walls is removable for easy access to food contents after microwaving.

4. The microwavable container of claim 1, containing one or more vegetable, protein, and/or carbohydrate food products sealed therein.

5. The microwavable container of claim 4, wherein the food products are coated or mixed with sauce or gravy in powdered, pellet or cube form.

6. A method of preserving and reconstituting food product comprising,
placing the food product in a free-standing, microwavable container containing an internal pressure release valve, and sealing the container,
subjecting the container to high pressure processing to preserve the food products,
maintaining the food product in a preserved state until time of reconstitution,
and subjecting the preserved food product contained in the sealed container to sufficient microwave energy to reconstitute the preserved food product,
wherein the reconstituted food product exhibits substantially original preserved organoleptic properties.

7. The method of claim 6, wherein the organoleptic properties include taste, texture, appearance and nutritional properties.

8. The method of claim 6, wherein the preserved food product comprises one or more vegetables, proteins, and/or carbohydrates.

9. The method of claim 8, wherein the preserved food products are coated or mixed with sauce or gravy in powdered, pellet or cube form.
